(19) United States
(12) Patent Application Publication
(10) Pub. No.: US 2026/0210736 A1
(43) Pub. Date: Jul. 23, 2026

(54) METHOD AND COMPUTER PROGRAM FOR DETERMINING THE POSITION OF A POSITION RECEIVING DEVICE RELATIVE TO A POSITION TRANMITTING DEVICE, POSITION DETERMINATION DEVICE, POSITION RECEIVING DEVICE, AND VEHICLE

(71) Applicant: MAHLE International GmbH, Stuttgart (DE)

(72) Inventors: Simon Joos, Ditzingen (DE); Siyuan Lu, Stuttgart (DE); Rudolf Walter, Stuttgart (DE); Mike Boettigheimer, Kornwestheim (DE)

(21) Appl. No.: 19/457,133

(22) Filed: Jan. 22, 2026

(30) Foreign Application Priority Data
Jan. 23, 2025 (DE) 102025102411.1

(51) Int. Cl. G01D 5/20; H02J 50/10; H02J 50/90

(52) U.S. Cl. CPC G01D 5/2066; H02J 50/10; H02J 50/90

(57) ABSTRACT

A method for determining the position of a position receiving device relative to a position transmitting device is disclosed. The position receiving device has a first receiving coil and a second receiving coil, which are arranged essentially in a receiving plane and whose radial longitudinal directions intersect at an intersection point. The method includes: receiving a first voltage signal induced in the first receiving coil by a transmitting coil of the position transmitting device; receiving a second voltage signal induced in the second receiving coil by the transmitting coil; evaluating the received voltage signals; and determining a direction angle between the radial longitudinal direction of the first receiving coil and an imaginary connecting line between the intersection point and the transmitting coil on the basis of the evaluated voltage signals.

### CROSS-REFERENCE TO RELATED APPLICATIONS

This application claims priority to German Patent Application No. DE 10 2025 102 411.1 filed Jan. 23, 2025, the contents of which are hereby incorporated by reference in their entirety.

### TECHNICAL FIELD

The invention relates to a method for determining the position of a position receiving device relative to a position transmitting device. The invention also relates to a corresponding computer program, a position determination device, a position receiving device, and a vehicle.

### BACKGROUND

There are a variety of situations in which a mobile device, such as a vehicle (e.g., a car, truck, robot, driverless transport vehicle, etc.), must be positioned at a specified location. The mobile device can be moved to the specified position manually (by a user, such as a driver or operator) or with the aid of an auxiliary device (such as a sled or conveyor belt, as used in car washes, for example). However, it is preferable for the mobile device to navigate to the specified position automatically and autonomously. In addition, manual positioning often requires information or an aid to help the user position the mobile device in the correct position.

Correct positioning of the induction charging devices relative to each other is crucial, especially for the implementation of an inductive charging process. A system for inductive energy transfer usually has a stationary and a mobile induction charging device. In a charging operation, one or more energy coils of the induction charging devices function as the primary coil and one or more energy coils of the other induction charging device function as the secondary coil.

The stationary induction charging device (also referred to as Ground Assembly (GA)) is usually located in or on the ground, and the mobile device features the mobile induction charging device (also referred to as Vehicle Assembly (VA)). In mobile devices, the energy coil of the mobile induction charging device is usually the secondary coil during charging operation. For inductive energy transmission, the primary coil generates an alternating magnetic field that induces a voltage in the secondary coil.

In order to enable inductive energy transfer and, in particular, to increase the efficiency of inductive energy transfer, the primary coil and the secondary coil, and thus the energy coils of the induction charging devices, must be positioned as precisely as possible relative to each other. For this purpose, the inductive energy transfer system can be equipped with a corresponding positioning device.

DE 10 2022 203 489 A1 discloses a system for inductive energy transfer, in particular to a mobile application, which comprises a stationary induction charging device with a stationary energy coil and a mobile induction charging device with a mobile energy coil. Precise and robust detection of the relative position of the energy coils in relation to each other is achieved using a positioning device, which has four transmitting coils in one of the induction charging devices and at least one receiver in the other induction charging device. The transmitting coils generate distinguishable positioning fields that interact with the at least one receiver, wherein the ratio of the positioning fields is used to detect whether the energy coils overlap each other.

DE 10 2022 107 569 A1 discloses a method for positioning a vehicle with a mobile inductive charging device in a defined position relative to a stationary inductive charging device. The mobile inductive charging device or the stationary inductive charging device has a first sensor winding with a first radial longitudinal direction and a second sensor winding with a second radial longitudinal direction. The first radial longitudinal direction and the second radial longitudinal direction are at an angle of between 70° and 110° to each other, preferably perpendicular to each other and at an angle between 350 and 550 to the longitudinal direction of the vehicle or to the intended longitudinal direction of the vehicle, preferably at a 45° angle to the longitudinal direction of the vehicle or to the intended longitudinal direction of the vehicle. A positioning signal generates a first voltage signal in the first sensor winding and a second voltage signal in the second sensor winding. The at least one first voltage signal is detected in a signal detection unit, and the at least one second voltage signal is detected in a signal detection unit. An evaluation unit converts the first voltage signal into a first digital signal and the second voltage signal into a second digital signal, and processes and compares the first digital signal and the second digital signal. The processing of the first digital signal and the second digital signal includes a transformation into the frequency domain, and a directional deviation value between the longitudinal direction of the vehicle and the connecting line between the stationary inductive charging device and the mobile inductive charging device is calculated from the comparison of the first digital signal with the second digital signal.

DE 10 2022 107 568 A1 discloses an inductive charging device for a vehicle charging system with an energy transfer winding and at least one flux guide element and with at least one first sensor winding and one second sensor winding. The flux guide element is suitable for guiding a magnetic field during energy transfer between a further inductive charging device and the energy transfer winding, and the first sensor winding and the second sensor winding are arranged around at least one of the at least one flux guide element. A voltage is induced in the sensor windings by the magnetic field of a positioning signal winding. This voltage is proportional to the component of the magnetic field that is perpendicular to the respective radial longitudinal direction of the sensor winding. These voltages can be used to determine the position of the vehicle in relation to the inductive charging device.

The positioning devices used for this purpose are often referred to as “differential inductive positioning systems” (DIPS).

Currently known DIPS algorithms are generally based on the spatial distribution of the magnetic field from transmitting coils integrated into the stationary induction charging device. In order to achieve interoperability between different GA and VA manufacturers, it has therefore been necessary up to now for different GAs to generate the same or a similar spatial distribution of the magnetic field.

However, the design of the GAs and VAs, particularly with regard to magnetic field shielding, the design of flux guide elements, etc., can vary considerably between different GA and VA manufacturers, which can result in significant deviations in the positioning magnetic fields without violating standardization criteria for contactless energy transfer.

A defined measurement method (e.g., conformity tests defined in the SAE J2954 “Surface Vehicle Standard” of August 2024) checks the generated magnetic field with tolerances, but previous DIPS algorithms in combination with previous DIPS hardware for position determination can only cope with defined tolerances. If these tolerances are small, the design freedom of VA and GA for contactless energy transfer is consequently restricted. In other words, interoperability for DIPS based on currently known algorithms can severely limit design freedom for contactless energy transfer.

In addition, the well-known DIPS algorithm can only provide x and y coordinates with lower accuracy, which can lead to insufficient user performance.

The well-known DIPS algorithm is based on absolutely measured induced voltages or on ratios between absolutely measured induced voltages. Although the use of ratios reduces the influence of metallic objects in the environment, for example, the influence of changes caused by the flow control element of the GA and the shielding of the GA remains significant.

In addition, the well-known DIPS algorithm depends on the z-height, i.e., the vertical distance between VA and GA. In particular, positioning accuracy is impaired if the ground clearance of the VA changes due to loading or for any other reason and the parameter configuration of the software is not adjusted accordingly.

### SUMMARY

The present invention addresses the task of overcoming the aforementioned problems and, in particular, improving the accuracy of position determination. The aim is to improve and simplify interoperability between different induction charging devices on the primary and secondary sides.

The task is solved by the independent claim(s) in each case.

According to a first aspect, a method for determining the position of a position receiving device relative to a position transmitting device is proposed to solve the problem, wherein the position receiving device has a first receiving coil and a second receiving coil, which are arranged substantially in a receiving plane and whose radial longitudinal directions intersect at an intersection point, with
receiving a first voltage signal induced in the first receiving coil by a transmitting coil of the position transmitting device,
receiving a second voltage signal induced in the second receiving coil by the transmitting coil,
evaluating the received voltage signals; and
determining a (particularly smaller) direction angle between the radial longitudinal axis of the first receiving coil (or the second receiving coil) and an imaginary connecting line between the intersection point and the transmitting coil based on the evaluated voltage signals.

According to a second aspect, a computer program is proposed, wherein the computer program comprises program code means for causing a computer to execute the steps of the method when the computer program is executed on the computer.

According to a third aspect, a position determination device for determining the position of a position receiving device relative to a position transmitting device, wherein the position receiving device has a first receiving coil and a second receiving coil, which are essentially arranged in a receiving plane and whose radial longitudinal directions intersect at an intersection point, with
a receiving unit for receiving a first voltage signal induced in the first receiving coil by a transmitting coil of the position transmitting device and for receiving a second voltage signal induced in the second receiving coil by the transmitting coil, and
an evaluation unit for evaluating the received voltage signals and for determining a direction angle between the radial longitudinal direction of the first receiving coil (or the second receiving coil) and an imaginary connecting line between the intersection point and the transmitting coil on the basis of the evaluated voltage signals, and
an output unit for providing the direction angle.

According to a fourth aspect, a position receiving device is proposed which is designed to interact with a position transmitting device, with
a receiving unit with at least three receiving coils, each of which has a radial longitudinal direction and is designed to receive a voltage signal induced by a transmitting coil of the position transmitting device, wherein the receiving coils are arranged essentially in a receiving plane and the radial longitudinal directions intersect at an intersection point, and
a connection for supplying the induced voltage signals to a position determination device (according to the invention).

According to a fifth aspect, a vehicle with a position receiving device (according to the invention) is proposed.

Advantageous embodiments are described in the dependent claims, among other places. It should be noted that additional features of a patent claim dependent on an independent patent claim, without the features of the independent patent claim or only in combination with a subset of the features of the independent patent claim, may constitute a separate invention independent of the combination of all features of the independent patent claim, which may be the subject of an independent claim, a divisional application, or a subsequent application. This applies equally to technical teachings described in the description which may constitute an invention independent of the features of the independent patent claims.

The idea behind the present invention is to determine the position of the position receiving device relative to the position transmitting device solely by means of angle determination(s). If the position receiving device and the position transmitting device are each part of an induction charging device, or if the (magnetic) center of the position transmitting device is located at a defined distance from the induction charging device, the position of one induction charging device relative to the other induction charging device can be determined solely by the angle determination(s). The direction angle between the radial longitudinal direction and the aforementioned connecting line is preferably the smaller of the two possible angles. The angle should be determined so that it lies between −90° and +90° (inclusive).

The position receiving device is preferably located in a vehicle or a VA with an induction charging device. This means that at least two receiving coils, preferably integrated into a VA, are used to calculate the respective direction angles to one or more transmitting coils (preferably integrated into the GA), which, for example, generate an alternating magnetic field with a specific frequency. In doing so, the transmitting coils preferably generate an alternating magnetic field with a predetermined but different frequency in each case.

Overall, the design of the DIPS proposed in this invention can thus be largely decoupled from the design of GA and VA.

The direction angle determined can be used to derive position information regarding the position of the position transmitting device relative to the position receiving device, which can then be used, for example, to navigate an autonomous vehicle (which has one of the two devices) to a desired position or to provide navigation information to the user of a mobile device, e.g., a motor vehicle or forklift truck, so that they can move the mobile device to the desired position. This does not require strict magnetic field consistency in relation to the transmitting coils or precise knowledge of the vehicle height.

A position receiving device can be used to implement the method according to the invention, wherein the position receiving device has a receiving coil unit with two (or more) receiving coils, each of which has a radial longitudinal direction and is designed to be inductively supplied with a voltage or have a voltage signal induced in them by a respective transmitting coil of a position transmitting device, wherein the receiving coils are arranged essentially in a receiving plane and the radial longitudinal directions intersect at an intersection point. The intersection point is preferably located along the radial longitudinal direction, respectively, in the center of the receiving coils or in the middle of their main extension. In addition to the receiving coil unit, the position receiving device may have a connection for supplying voltage signals to a position determination device, wherein the voltage signals correspond to the induced voltages.

Generally speaking, a coil is defined here as a component for generating or receiving a magnetic field. A coil can consist of a winding and optional further elements such as a magnetic core and a coil former. A winding is a coiled arrangement of a conductor. A winding can consist of one or more turns, wherein a turn refers to a full revolution of a conductor. Generally speaking, a winding can also consist of less than one turn, for example 0.5 turns. Of course, an incomplete number of turns, such as 2.5 turns, is also possible.

The receiving coils or windings can be designed in different shapes and have half a turn, one turn, or preferably several turns. A conductor of such a receiving winding may, for example, have a cross-sectional area between 0.01 mm² and 2 mm². A conductor can be designed here as a stranded wire, as a single conductor, or in another form, for example as a so-called “flexible flat cable” or in the form of conductor tracks on printed circuit boards.

In general, a winding extends in at least two dimensions around a winding axis. The winding axis is the axis around which the winding is wound. The main direction of extension perpendicular to the winding axis is referred to here as the radial longitudinal direction. In a winding with a rectangular rather than square cross-section, the radial longitudinal direction therefore runs along or parallel to the longer side of the rectangle. In the case of a winding with an elliptical cross-section, the radial longitudinal direction runs along or parallel to the main axis of the ellipse.

An alternating electromagnetic or magnetic field (generated in the transmitting coil(s)) can induce an alternating voltage in each of the receiving coils, which in turn can cause a current to flow in the conductor from which the respective receiving coils are formed. The alternating voltage induced in the first receiving coil is referred to as the first voltage signal, the alternating voltage induced in the second receiving coil as the second voltage signal, and so on for additional receiving coils. The voltage signals can then be made available to a position determination device for further evaluation.

The power transmitted by induction between the transmitting coil or coils and the receiving coils is preferably significantly lower than the power transmitted during energy transfer between associated induction charging devices. This applies in particular if the associated induction charging devices are intended for charging vehicle batteries.

Using the position determination device, the direction angle of the position receiving device relative to the position transmitting device can be determined or calculated using the voltage signals. The position determination device is preferably housed externally, for example in a computer or a processor arrangement. However, the position determination device may also be arranged in the position receiving device itself.

The position receiving device (and likewise the position transmitting device) as well as the position determination device is designed as a stand-alone device and can be used flexibly, i.e., it is not permanently attached to another device, but can also be permanently attached to another device, for example as an additional accessory or as a retrofit component. The position receiving device can, for example, be permanently attached or installed on the underside of a vehicle, or it can be mobile and removable, for example by means of a clamping or screw device.

As already mentioned, a computer program is also proposed, which comprises program code means for causing a computer to execute the steps of the method when the computer program is executed on the computer. The term “computer” should be interpreted broadly. Any computer or processor falls under the term “computer” in this context. In particular, the computer may be a single-chip computer or a microcontroller.

The GA transmission topology currently proposed for precise positioning in DIPS is a circular coil, and the proposed VA reception topology is a solenoid coil. In other words, the proposed positioning algorithm can be adapted to the DIPS in accordance with the SAE J2954 “Surface Vehicle Standard” from August 2024 and other positioning systems with the same topological combination.

With regard to the application scenarios described above, the position receiving device according to the invention is preferably arranged in, on, or at a defined distance from a (mobile or stationary) induction charging device (and thus associated with an induction charging device). The same applies preferably to the position transmitting device. Both devices are preferably designed to interact with each other for the purpose of determining their relative positions, in order to ensure that the associated induction charging devices can be aligned with each other as optimally as possible, so that the most optimal charging operation possible can take place for wireless energy transfer between the respective induction charging devices.

In a preferred embodiment of the method, the evaluation of the voltage signals includes an evaluation of the amplitude and the phase relationship of the voltage signals.

The magnitude of the direction angle can be determined based on the amplitude of the voltage signal. The phase relationship provides information about the sign of the direction angle, i.e., in which direction (“left” or “right”) the direction angle extends from the radial longitudinal direction of the respective receiving coil.

In one embodiment of the method, the method further comprises the following steps:
determining multiple circular sectors in the receiving plane from the intersection point;
associating the circular sectors with the (in particular different) voltage signals of the receiving coils; and
determining, based on the direction angle, in which circular sector the transmitting coil is located.

The circular sectors are preferably determined/divided by the receiving coils or their radial longitudinal directions. For example, four circular sectors can be determined for two intersecting receiving coils. Six circular sectors can be determined for three intersecting receiving coils, etc.

According to a preferred embodiment, when a minimal first voltage signal is present, it is determined that the direction angle is essentially 0°; and/or, if the voltage signals have the same amplitude and opposite phase, it is determined that the direction angle is essentially half of an angle between the radial longitudinal direction of the first receiving coil and the radial longitudinal direction of the second receiving coil.

In general, the presence of a minimal voltage signal can be used to determine that the corresponding receiving coil is essentially directed toward the transmitting coil; and/or the same amplitude and opposite phase of any two voltage signals are used to determine that the transmitting coil is essentially located at an intermediate angle between the two corresponding transmitting coils.

In another preferred embodiment, at least the first voltage signal is induced by one or more additional transmitting coils of the position transmitting device, wherein the first voltage signal comprises a first partial voltage induced by the transmitting coil and one or more additional partial voltages induced by the one or more additional transmitting coils, wherein the method further comprises
evaluating one or more additional partial voltages of the first voltage signal; and
determining one or more additional direction angles between the first radial longitudinal direction and the imaginary connecting line between the intersection point and the one or more additional transmitting coils based on the one or more additional evaluated partial voltages of the first voltage signal.

In other words, if the position transmitting device has several transmitting coils, for example a first transmitting coil and a second transmitting coil, a first partial voltage (of the first voltage signal) from the first transmitting coil and a second partial voltage (of the first voltage signal) from the second transmitting coil are induced in the first receiving coil, so that the first voltage signal is composed of a first partial voltage and a second partial voltage, and a first partial voltage (of the second voltage signal) from the first transmitting coil and a second partial voltage (of the second voltage signal) from the second transmitting coil can be induced in the second receiving coil, so that the second voltage signal is composed of a first partial voltage and a second partial voltage. Preferably, the first and second induced partial voltages differ from each other. This can be achieved, for example, by using transmitting coils whose alternating magnetic fields are generated at different frequencies or at the same frequency but with different pulse widths. This means that several different partial voltages are available. If two transmitting coils are present, direction angles can then be determined between the radial longitudinal direction of the first receiving coil (and/or the second receiving coil) and the respective imaginary connecting lines between the intersection point and two transmitting coils.

It is generally advantageous if, in the case of multiple transmitting coils, the transmitting coils generate alternating magnetic fields that can be distinguished from one another or differ in such a way that the partial voltages induced in the receiving coils can be distinguished in such a way that it is clear from which transmitting coil the respective partial voltage was induced. If more than one transmitting coil is arranged on a GA, the relative position between the receiving coils and the transmitting coils (or a VA with the receiving coils and the GA with the transmitting coils) can be derived using the method according to the invention by simultaneously taking into account each individual direction angle of the VA relative to each of the transmitting coils.

By evaluating at least one additional transmitting coil on the GA, which generates an alternating magnetic field with a frequency different from that of the first transmitting coil, the x-y position of the VA relative to the GA (in the immediate vicinity of the GA and above the GA; with known orientation of the VA in the x-y coordinate system) can be calculated. In total, any number of transmitting coils and receiving coils are possible, which can increase the accuracy of position determination, but is always based on the same operating principle.

In a particularly preferred embodiment, the method comprises, when the first voltage signal is induced by at least two further transmitting coils, evaluating a first partial voltage of the first voltage signal induced by the transmitting coil and two further partial voltages of the first voltage signal induced by the two further partial voltages, further determining whether the intersection point K is located within a range spanned by the at least three transmitting coils, in particular their axes.

In particular, the method preferably comprises (provided that the first voltage signal is induced by at least three transmitting coils) determining an (absolute) orientation of the position receiving device in the receiving plane, i.e., determining a rotation angle between a coordinate system associated with the position receiving device (in the receiving plane) and a coordinate system associated with the position transmitting device (in the receiving plane).

If there are two transmitting coils, two direction angles can be determined relative to a receiving coil: one in relation to one transmitting coil, the other in relation to the other transmitting coil. This results in a limited number of possible positions for the receiving coil in relation to the transmitting coils. If there are additional transmitting coils (i.e., if there are three transmitting coils), a total of three direction angles can be determined relative to a receiving coil. This allows the (absolute) orientation (and position) of the receiving coil in the receiving plane to be clearly determined.

In a preferred embodiment, the method further comprises taking into account the influence of a flow guide element, around which one of the receiving coils is wound or on which the transmitting coil is arranged, on the evaluated associated voltage signal when determining the direction angle.

If the receiving coils are wound around a flux guide element, such as a ferrite, the self-inductance of the receiving coils varies depending on the size and arrangement of the ferrite. Consequently, in a practical system, the receiving coils generate different induced voltages even when they are in the same position. This effect is preferably taken into account in the method for determining the direction angle.

Similarly, the magnetic field of the transmitting coil can also be influenced by a flux guide element.

In one embodiment of the position receiving device, in particular, all angles between radial longitudinal directions of adjacent receiving coils are essentially equal in each case. In principle, however, any angles, especially different angles, between the respective radial longitudinal directions of adjacent receiving coils are possible.

In a receiving coil unit with three receiving coils, this means that the angles between the radial longitudinal directions of adjacent receiving coils are essentially 600 in each case. With four receiving coils, the angles mentioned are essentially 450 in each case. For n receiving coils, the angle is calculated using the formula 360°/(2*n).

In this context, the term essentially refers to a deviation of a few degrees, for example±5°. In a further embodiment of the position receiving device, at least one of the receiving coils is designed as a solenoid coil (also known as a cylinder coil) and/or at least one of the receiving coils is wound around one or more flux guide elements.

In a particularly preferred embodiment, the position receiving device (more precisely, its receiving coil unit) has more than three receiving coils, each of which has a radial longitudinal direction and is designed to receive a voltage signal (or partial voltage) from one (or more) transmitting coils of the position transmitting device, wherein the receiving coils (preferably all) are arranged essentially in a receiving plane and the radial longitudinal directions intersect at an intersection point.

In a preferred configuration of the vehicle, the vehicle also has an induction charging device in addition to the position receiving device.

In this respect, the position receiving device (according to the invention) can be arranged in, on, or near a mobile induction charging device (of the vehicle).

In principle, it is also conceivable that the position receiving device is located on or near a stationary induction charging device (and the position transmitting device is located on a mobile induction charging device).

The position determination device may also be located inside the vehicle. However, the position determination device may also be located in a completely different place. For example, it is conceivable that a central server determines the position of the position receiving device relative to a position transmitting device and provides the direction angle to a navigation system or similar within the vehicle.

It is understood that the features mentioned above and those explained below can be used not only in the combinations specified, but also in other combinations or individually, without departing from the scope of the present invention.

The various optional configurations that have been explained or will be explained here and relate to the method according to the invention apply equally to the computer program according to the invention, the position determination device according to the invention, and the position receiving device according to the invention, and vice versa.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

The figures below schematically show:

FIG. 1 illustrates a vehicle illustrating an example application scenario of the present invention;

FIG. 2 illustrates an example arrangement with a position transmitting device and a position receiving device;

FIG. 3 illustrates an example of a transmitting coil in the form of a circular coil;

FIG. 4 illustrates an example of a receiving coil in the form of a solenoid coil with a single turn;

FIG. 5 illustrates an example arrangement consisting of a GA with a position transmitting device and a VA with a position receiving device.

FIG. 6 illustrates an exemplary embodiment of the method according to the invention for determining the position of a position receiving device relative to a position transmitting device.

FIGS. 7A and 7B illustrate a first and second exemplary embodiment, respectively, of the position receiving device (of a VA) according to the invention next to a position transmitting device;

FIGS. 8A, 8B and 8C illustrate an arrangement of an exemplary embodiment of a position transmitting device and an exemplary embodiment of a position receiving device;

FIG. 9 illustrates an example arrangement consisting of a position transmitting device with two transmitting coils and a position receiving device with three receiving coils;

FIG. 10 illustrates an example arrangement of receiving and transmitting coils;

FIG. 11 illustrates another example arrangement with multiple receiving and transmitting coils.

FIGS. 12A and 12B illustrate an exemplary embodiment of a position receiving device according to the invention;

FIG. 13 illustrates position transmitting device with a transmitting coil and several flux guide elements; and

FIG. 14 illustrates an exemplary embodiment of a position receiving device according to the invention with three transmitting coils.

### DETAILED DESCRIPTION

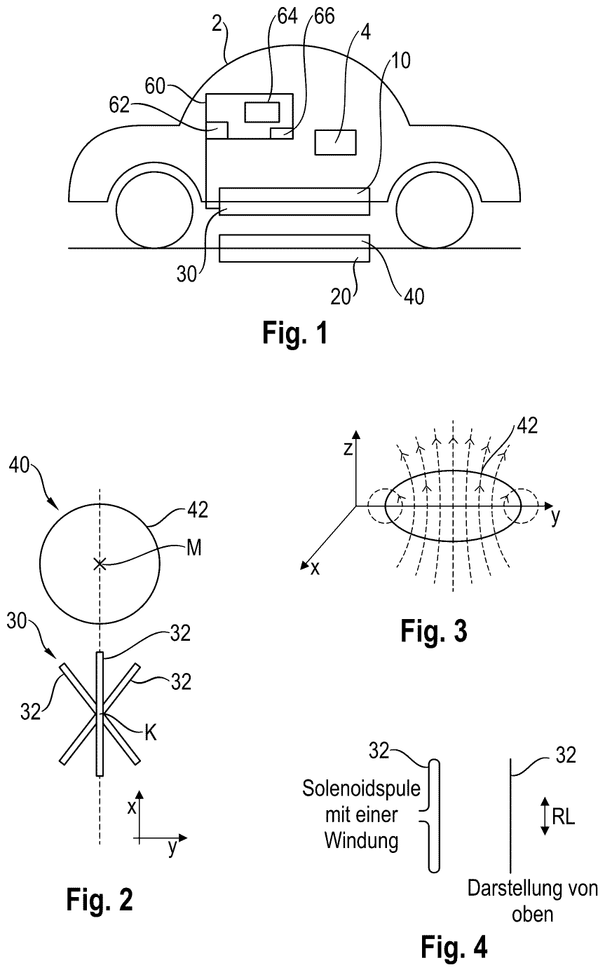

FIG. 1 shows, in particular, a mobile induction charging device 10 that is arranged on a vehicle 2 with a battery 4 and is positioned spatially above a stationary induction charging device 20. During operation, energy can be transferred from the stationary induction charging device 20 to the mobile induction charging device 10, thereby charging the battery 4. It is also conceivable that energy can be transferred from the mobile induction charging device 10 to the stationary induction charging device 20, at least temporarily.

For efficient energy transfer between a stationary induction charging device 20 and the mobile induction charging device 10 of the vehicle 2, the induction charging devices must be positioned as precisely as possible in a defined position relative to each other. The defined position is a predetermined position that is preferred to ensure that energy can be transmitted with the highest possible efficiency. In particular, it can be taken into account that the energy transfer windings of the energy coils in the two induction charging devices are positioned opposite each other with as little distance as possible between them and with an air gap between them. Since both energy transfer windings do not generally need to be the same size, symmetrical positioning, in which the winding axes of the two energy transfer windings are aligned as closely as possible, is also advantageous. Precise positioning, especially when it has to be carried out by a driver of a vehicle with an induction charging device, is often difficult or impossible without additional support in the form of a driver assistance system.

In order to ensure the most accurate positioning possible, vehicle 2 also has a position receiving device 30, which is designed to interact with a stationary (ground-based) position transmitting device 40. The position receiving device 30 is specifically designed to receive a position signal from the position transmitting device 40, which can then be used to determine the position of the two devices relative to each other, for example via the position determination device 60. The position determination device 60 has a receiving unit 62, an evaluation unit 64, and an output unit 66 for this purpose.

The stationary induction charging device 20 shown in FIG. 1 on the ground can alternatively also be recessed into the roadway (not shown here). In a recessed arrangement, the induction charging device 20 can be covered by certain layers of the roadway or can be flush with the road surface. Similarly, the position transmitting device 40 does not have to be located below the road surface as shown, but can also be located above it. In principle, it is also conceivable that the position transmitting device 40 is (partially) arranged within the stationary induction charging device 20, or vice versa.

The arrangement of the position receiving device 30 and the mobile induction charging device 10 in/on the vehicle can also be adapted as required and is not limited to the arrangement shown.

FIG. 2 schematically shows an exemplary arrangement with a position transmitting device 40 and a position receiving device 30. The position transmitting device 40 consists of a single transmitting coil 42 in the arrangement shown in FIG. 2. The transmitting coil 42 is a circular coil. The position receiving device 30 comprises a single receiving coil 32, which in this case is a solenoid coil, as also shown in FIG. 4. The position transmitting device 40 and the position receiving device 30 are arranged next to each other and shown in a top view (i.e., in the indicated x-y plane), with the position receiving device shown in three different positions A, B, and C.

When current is applied to the transmitting coil 42, it generates a magnetic field whose field lines run through the blade plane within the transmitting coil 42. In other words, the magnetic field generated by the circular coil around the axis M of the transmitting coil 42 is rotationally symmetrical in the x-y plane. A perspective view of the magnetic field distribution can be seen in FIG. 3. In position A, the radial longitudinal direction of the receiving coil 32 runs along line V, which extends through the axis M of the transmitting coil 42. In this position, the induced voltage in the solenoid coil is zero due to symmetry. If the solenoid coil does not point to axis M or does not run along line V, as shown in positions B and C, a voltage is induced in the solenoid coil. Using the current in the circular coil as a reference, a voltage is induced in a solenoid coil in position B relative to position C, which has an opposite phase (compared to the voltage induced in position C). If positions B and C are symmetrical to position A, voltages with equal amplitudes but opposite directions or opposite phases are induced in the solenoid coil at positions B and C.

FIG. 3 schematically shows an example of a transmitting coil 42 in the form of a circular coil in space. In addition to the coil itself, a magnetic field distribution around the coil is shown when current flows through the coil.

FIG. 4 schematically shows an example of a receiving coil 32 in the form of a solenoid coil with a single turn. On the left-hand side, a perspective view of the solenoid coil is shown. On the right-hand side, a view of the solenoid coil from above is shown. The radial longitudinal direction of the solenoid coil, i.e., the main direction of extension perpendicular to the winding axis of the solenoid coil, is marked with “RL.”

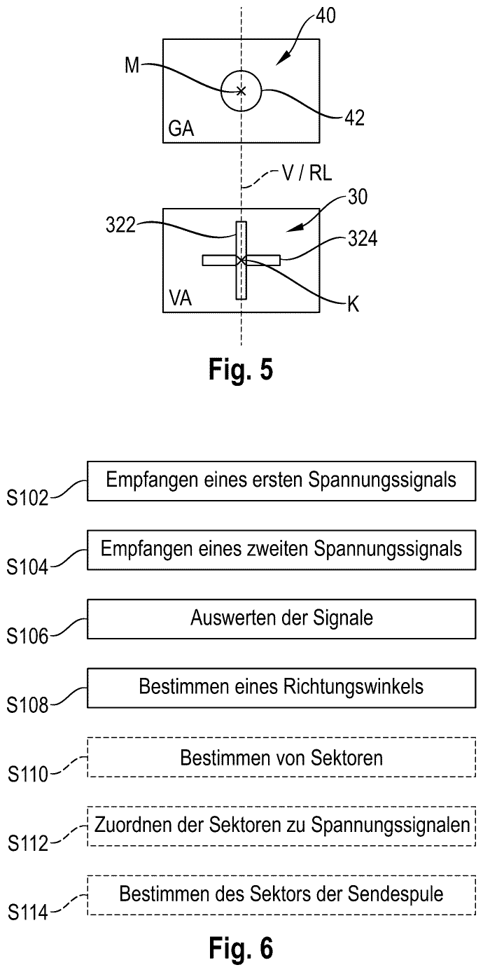

FIG. 5 schematically shows an example arrangement consisting of a GA with a position transmitting device 40 and a VA with a position receiving device 30. The position transmitting device 40 comprises a transmitting coil 42, which is designed as a circular coil. The position receiving device comprises a first receiving coil 322 and a second receiving coil 324, whose radial longitudinal directions intersect at an intersection point K and which are arranged at an angle of essentially 90° to each other. The radial longitudinal direction of the first receiving coil 322 runs along line V, which extends through the axis M of the transmitting coil 42 and the intersection point K. As a result, minimal voltage can be induced in the first receiving coil 322 from the transmitting coil 42. In contrast, the voltage induced in the second receiving coil 324 is maximum due to its orientation relative to the circular transmitting coil 42. With the orientation of the position receiving device 30 shown, it is therefore very easy to determine whether the position receiving device 30 or VA is positioned relative to the position transmitting device 40 or GA in such a way that the radial longitudinal direction RL of the first receiving coil 322 runs along the line V.

With a position receiving device 30 designed as a 450 cross coil (which also has two intersecting receiving coils that are rotated, for example, 45° clockwise around the intersection point K relative to the arrangement in FIG. 5), it is also possible in principle to approximate the induced voltage and the phase relationship of a fictitious 0-degree cross coil using the method according to the invention.

FIG. 6 shows an exemplary embodiment of the method according to the invention for determining the position of a position receiving device relative to a position transmitting device. It is assumed that the position receiving device has a first receiving coil and a second receiving coil, which are arranged essentially in a receiving plane and whose radial longitudinal directions intersect at an intersection point (as shown, for example, in FIG. 5). The position transmitting device has at least one transmitting coil. In a first step S102 of the method, a first voltage signal induced in the first receiving coil by the transmitting coil is received. In a second step S104, a second voltage signal induced in the second receiving coil by the transmitting coil is received. In a third step S106, the received voltage signals are evaluated, in particular with regard to their amplitude and phase. In a fourth step S108, a (first) direction angle is determined on the basis of the evaluated voltage signals, wherein the (first) direction angle is defined as the angle between the radial longitudinal direction of the first receiving coil and an imaginary connecting line between the intersection point and the transmitting coil. Alternatively or additionally, a second direction angle (between the radial longitudinal direction of the second receiving coil and an imaginary connecting line between the intersection point and the transmitting coil) can be determined. In an optional fifth step S110, several (circular) sectors are determined in the receiving plane from the intersection point (as the center of the circle). The sectors are preferably divided along the radial longitudinal directions or separated from each other by these. In an optional sixth step S112, the sectors are associated with different direction angle ranges and/or voltage signals or voltage signal relationships of the receiving coils. For example, a circular sector that includes line V in FIG. 5 and covers an angle of, for example, 20° could be associated with a voltage signal that is zero or only slightly different from zero for the first receiving coil 322 (and essentially reaches a maximum for the second receiving coil 324). In this respect, associating the circular sectors with the voltage signals is advantageously performed on the basis of the expected voltage that would be induced in the receiving coils if they were located in the sector in question. In an optional seventh step S114, the calculated direction angle (or the voltage signals) can then be used to determine in which of the circular sectors the transmitting coil is located.

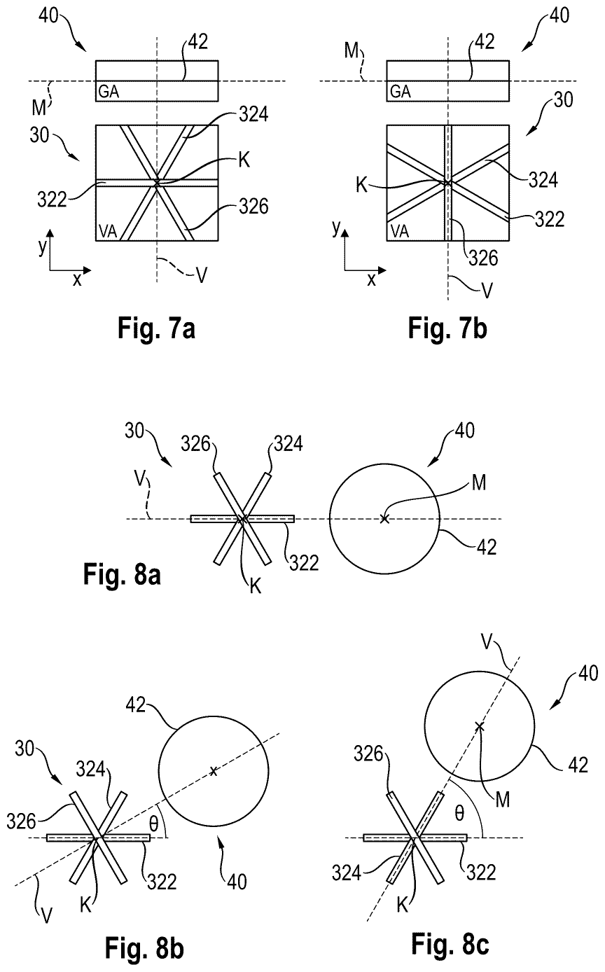

FIGS. 7A and 7B schematically show a first and second exemplary embodiment, respectively, of the position receiving device 30 (of a VA) according to the invention next to a position transmitting device 40 (of a GA) in a top view. The position receiving device 30 comprises a receiving coil unit with three receiving coils 322, 324, and 326, each of which has a radial longitudinal direction and is designed to receive a voltage signal from a respective transmitting coil of a position transmitting device (not shown) or to be inductively supplied with a voltage. The three receiving coils 322, 324, and 326 are essentially arranged in a receiving plane, in this case the x-y plane, and the radial longitudinal directions of the receiving coils 322, 324, and 326 intersect at the intersection point K. The position receiving device 30 further comprises (in each case) a connection for supplying the voltage signals to a position determination device (the voltage signals correspond to the induced voltages). However, the connection is not shown in FIGS. 7A and 7B. The position transmitting device 40 comprises a transmitting coil 42, which is designed as a horizontal field coil. The receiving coils 322, 324, and 326 are designed as solenoid coils. This means that when a (fictitious) receiving coil is aligned so that the radial longitudinal direction of the (fictitious) receiving coil is essentially perpendicular to the axis M of the transmitting coil 42, (virtually) no voltage is induced in the receiving coil.

In both embodiments of the position receiving device 30, the angle between adjacent receiving coils is essentially 60° in each case. This arrangement ensures that at least two of the receiving coils are always not perpendicular to the transmitting coil 42, which is designed as a horizontal field coil, and obtain a reliable (non-zero) induced voltage for detecting the direction of the position transmitting device 40 or the GA, thereby avoiding blind spots. If the receiving coils 322, 324, and 326 of the position receiving device 30 are arranged along the direction of travel y or opposite the position transmitting device/GA, as shown in FIG. 7A, a voltage is induced in all three receiving coils 322, 324, and 326. This is particularly because none of the receiving coils 322, 324, and 326 are arranged along line V. In FIG. 7B, however, this is the case. In the position receiving device 30 shown there, the receiving coils 322, 324, and 326 are rotated clockwise by approximately 30° around the intersection point K relative to the arrangement in FIG. 7A, so that the radial longitudinal direction of the receiving coil 326 is perpendicular to the axis M of the transmitting coil 40. Therefore, no voltage can be induced in the receiving coil 326 by the transmitting coil 42 if VA and GA are aligned in the x and y directions, respectively, as shown in FIG. 7B. Nevertheless, two receiving coils 324 and 322 remain, in which a (non-vanishing) voltage can be induced.

In principle, the number of receiving coils 32 of the position receiving device 30 can be increased arbitrarily in order to obtain information about the magnetic field in further directions. The angle between the receiving coils 32 can be any value. The angle between adjacent receiving coils can be the same in each case, but it can also take on different values.

FIGS. 8A, 8B, and 8C each show a top view of an arrangement of an exemplary embodiment of a position transmitting device 40 and an exemplary embodiment of a position receiving device 30, wherein the arrangements differ only in the orientation of the position receiving device 30 relative to the position transmitting device 40. The position receiving device 30 comprises a receiving unit with a first receiving coil 322, a second receiving coil 324, and a third receiving coil 326. The receiving coils 322, 324, and 326 are arranged in a star shape in a (receiving) plane and are each designed as solenoid coils whose radial longitudinal directions intersect at an intersection point K. The angle between adjacent receiving coils is 600 in each case. The position transmitting device 40 has a single transmitting coil 42, which is designed as a circular coil.

In FIG. 8A, the angle θ between the radial longitudinal direction of the first receiving coil 322 and the line V extending (in the receiving plane) through the intersection point K and the axis M of the transmitting coil 42 is 0°. Thus, the voltage induced in the first receiving coil 322 is u1=0. Furthermore, due to the given topology, u2−u3=0, wherein u2 is the voltage induced in the second receiving coil 324 and u3 is the voltage induced in the third receiving coil 326.

In FIG. 8B, the angle θ between the radial longitudinal direction of the first receiving coil 322 and the line V extending (in the receiving plane) through the intersection point K and the axis M of the transmitting coil 42 is 30°. Consequently, u1-u3=0 applies.

In FIG. 8C, the angle θ between the radial longitudinal direction of the first receiving coil 322 and the line V extending (in the receiving plane) through the intersection point K and the axis M of the transmitting coil 42 is 60°, so that u3=0 and u1-u2=0.

Similarly, similar conditions can also be found at θ=90°, 0=120°, and θ=150°. This means that the range from 0 to 180 degrees can be divided into six circular sectors (each with an angle range of 30°), which can be individually distinguished by the signs of u1, u2, u3, u1-u2, u2-u3, and u1-u3.

Therefore, the algorithm for determining the direction angle describing the position of the position transmitting device 40 relative to the position receiving device 30 can be described more generally as follows:

$${u}_{α} = ( cos ( 0 ° ) * {u}_{1} + cos ( 120 ° ) * {u}_{2} + cos ( 240 ° ) * {u}_{3} )$$

$${u}_{β} = ( sin ( 0 ° ) * {u}_{1} + sin ( 120 ° ) * {u}_{2} + sin ( 240 ° ) * {u}_{3} )$$

$$θ = atan ( \frac{{u}_{β}}{{u}_{α}} ) .$$

The direction angle θ can be used to determine the (circular) sector in which the position transmitting device 40 is located, or to directly determine the angle at which the position transmitting device 40 is located relative to the position receiving device 30.

In principle, the above algorithm can be extended to a position receiving device 30 with n receiving coils 32, wherein the angle between each adjacent receiving coil 32 can have any value:

$${u}_{α} = ( cos ( 0 ) * {u}_{1} + cos ( {φ}_{2} ) * {u}_{2} + ⋯ + cos ( {φ}_{m} ) {u}_{m} + ⋯ + cos ( {φ}_{n} ) * {u}_{n} )$$

$${u}_{β} = ( sin ( 0 ) * {u}_{1} + sin ( {φ}_{2} ) * {u}_{2} + ⋯ + sin ( {φ}_{m} ) {u}_{m} + ⋯ + sin ( {φ}_{n} ) * {u}_{n} )$$

$$θ = atan ( \frac{{u}_{β}}{{u}_{α}} ) .$$

Here, the angle φₘ is the angle between the mth receiving coil and the first receiving coil (reference coil) 322.

As the number of receiving coils 32 increases, the division into sectors becomes more precise and the resulting calculation of the direction angle becomes more accurate. The present algorithm for calculating the direction angle is particularly advantageous when the angle between the adjacent receiving coils 32 of the position receiving device 30 is the same in each case.

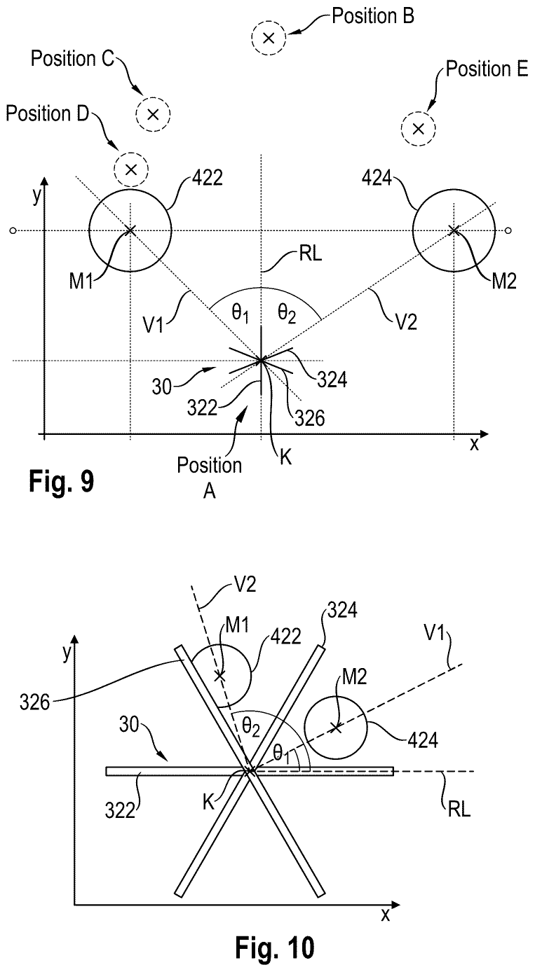

FIG. 9 shows an example arrangement of a position transmitting device 40 with two transmitting coils 422 and 424 and a position receiving device 30 with three receiving coils 322, 324, and 326 in a top view. The position transmitting device 40 and the position receiving device 30 are arranged in the x-y plane. The receiving coils are each solenoid coils, with the radial longitudinal direction of the receiving coil 322 (reference coil) designated RL. Although the longitudinal directions of the other receiving coils are not further specified, the angle between the longitudinal directions of adjacent receiving coils is 600 in each case. Transmitting coils 422 and 424 are circular coils, with the axes of the two coils designated M1 and M2, respectively. Furthermore, two connecting lines V1 and V2 are shown in FIG. 9, wherein V1 represents a connecting line between the axis M1 of the first transmitting coil 422 and the intersection point K of the receiving coils, and V2 represents a connecting line between the axis M2 of the second transmitting coil 424 and the intersection point K of the receiving coils.

The angles θ₁ and θ2 can be calculated based on measurements of the induced (partial) voltages in the respective receiving coils 322, 324, and 326. The angles θ₁ and θ₂ are shown here as examples in relation to the longitudinal direction RL of the receiving coil 322. The angle θ₁ is the angle between the first connecting line V1 and the radial longitudinal direction RL. The angle θ₂ is the angle between the connecting line V2 and the radial longitudinal direction RL. The angles θ₁ and θ₂ can be determined, in particular as explained with reference to FIGS. 8A, 8B, and 8C. With knowledge of the two angles θ₁ and θ₂ (and the location of the transmitting coils 422 and 424 within the x-y plane), it is possible to determine (at least roughly) the area in which the receiving coil 322 is located relative to the transmitting coils 422 and 424. Overall, knowing at least angles θ₁ and θ₂ greatly narrows down the possible positions of receiving coils 322, 324, and 326. Possible positions of the receiving coils 322, 324, and 326 are, for example, positions A, B, C, D, and E. Other positions on the corresponding (circular) line (not shown) are also conceivable.

FIG. 10 shows, like FIG. 9, an example arrangement of receiving and transmitting coils. As shown in FIG. 9, there are three receiving coils 322, 324, and 326, which are arranged in a star shape in the x-y plane and intersect at an intersection point K, with the angle between the radial longitudinal directions of adjacent receiving coils being 60° in each case. The intersection point K is located in the [sic]. The receiving coils 322, 324, and 326 are each solenoid coils, while the transmitting coils 422 and 424 are circular coils whose axes M1 and M2 run perpendicular to the blade plane. The radial longitudinal direction of the receiving coils 322, 324, and 326 is not shown, but runs along the longest dimension shown in each case. The connecting lines V1 and V2 run in the x-y plane through the intersection point K and the axes M1 and M2, respectively. The angle marked θ₁ indicates the angle between the radial longitudinal direction of the first receiving coil 322 and the connecting line V2, and the angle marked θ₂ indicates the angle between the radial longitudinal direction of the first receiving coil 322 and the connecting line V1. Similarly, the direction angles to the other two receiving coils 324 and 326 can be determined, allowing a precise statement to be made about the position of the receiving coils 322, 324, and 326 relative to the two transmitting coils 422 and 424.

In particular, it should be noted that if the orientation of the position receiving device 30 in the receiving plane (x-y plane) relative to the transmitting coils 422 and 424 is known, as shown in FIG. 10, the x-y position of the receiving coils can be calculated without taking into account the rotation/orientation of the receiver. In other words, if the orientation of the position receiving device 30 is known, the position of the position receiving device 30 relative to the transmitting coils 422 and 424 can be uniquely determined (other possible positions, as shown in FIG. 9, are thus excluded if the orientation in the x-y plane is known).

The accuracy of the estimated x-y position can be further improved by increasing the number of receiving and/or transmitting coils. In addition to the x-y position information, further information (such as the angle of rotation or the orientation of the receiving coils or the associated positioner detection unit) can also be determined.

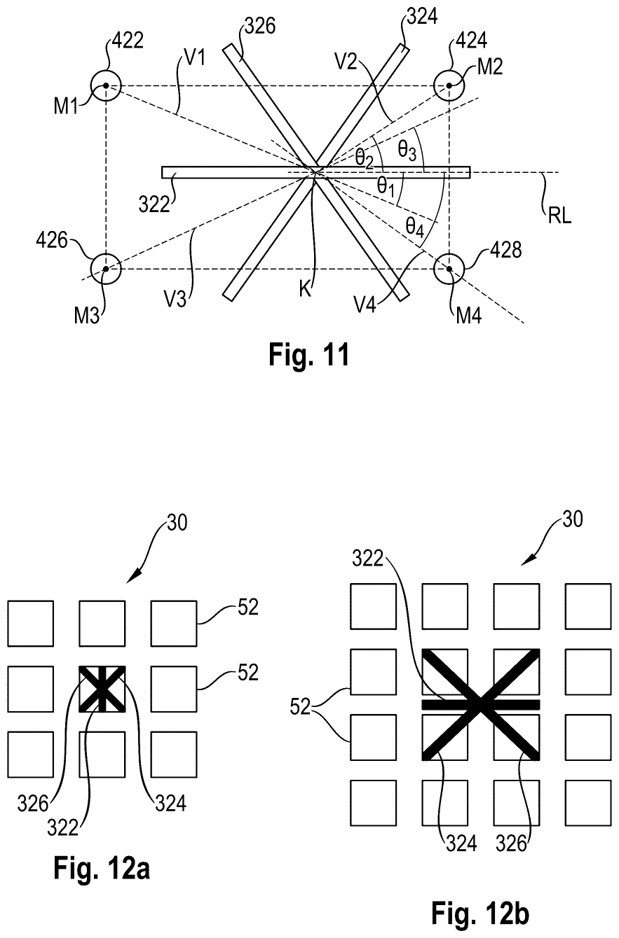

FIG. 11 shows another example arrangement with multiple receiving and transmitting coils. More specifically, FIG. 11 shows a top view of three receiving coils 322, 324, and 326 and four transmitting coils 422, 424, 426, and 428 (lying in one plane). The receiving coils intersect at the intersection point K, and the angle between the radial longitudinal directions of adjacent receiving coils is 60° in each case. The lines labeled V1 through V4 represent connecting lines between the intersection point K and the respective axes M1 through M4 of the transmitting coils. The transmitting coils are designed as circular coils and the receiving coils as solenoid coils. Other designs are also conceivable. It is crucial that the transmitting coils are designed in such a way that they generate (partial) voltages in a receiving coil that can be distinguished from one another. To do this, alternating currents of different frequencies are passed through the transmitting coils, for example, so that the direction angles to the transmitting coils can be determined based on the (partial) voltages induced by the transmitting coils in the receiving coils.

The angle θ₁ describes the (smaller) angle between the radial longitudinal direction RL of the first receiving coil 322 and the line V1, the angle θ₂ describes the (smaller) angle between the radial longitudinal direction RL of the first receiving coil 322 and the line V2, the angle θ₃ describes the (smaller) angle between the radial longitudinal direction of the first receiving coil 322 and line V3, the angle θ₄ describes the (smaller) angle between the radial longitudinal direction of the first receiving coil 322 and line V4.

These angles can be used to determine the position of the position receiving device 30 in relation to the transmitting coils 422 through 428, in particular unambiguously.

In other words, by analyzing the induced voltages in the frequency domain, the individual frequency components can be determined and used, for example, in the algorithm introduced above with reference to FIGS. 8A, 8B, and 8C to calculate the direction angles θ₁ through θ₄. Only angles between −90 and +90 degrees can be calculated, as these correspond to the value range of the atan function (therefore, the smaller angle must always be selected for the direction angle). If the following conditions are met simultaneously,

$$90 > {θ}_{1} > 0 ,$$

$$0 > {θ}_{2} > - 90 ,$$

$$90 > {θ}_{3} > 0 ,$$

$$0 > {θ}_{4} > - 90 ,$$

it can be determined whether the receiving coils (more precisely, the intersection point K) are located within the rectangular area spanned by the axes of the four transmitting coils in the blade plane.

FIG. 12A shows an exemplary embodiment of a position receiving device 30 (without connection) according to the invention. The position receiving device 30 comprises a receiving unit with three receiving coils 322, 324, and 326 intersecting at an intersection point in a plane, wherein the radial longitudinal directions of adjacent receiving coils each form an angle of 60°. In this case, the receiving coils 322, 324, and 326 are solenoid coils. The three receiving coils are wound around a single flux guide element 52 (e.g., ferrite), in particular around several flux guide elements of a VA.

FIG. 12B shows another exemplary embodiment of a position receiving device 30 (without connection) according to the invention, which is essentially constructed as in the exemplary embodiment shown in FIG. 12A. In contrast to the design shown in FIG. 12A, in FIG. 12 the receiving coils 322, 324, and 326 are wound around several, more precisely four, flux guide elements 52.

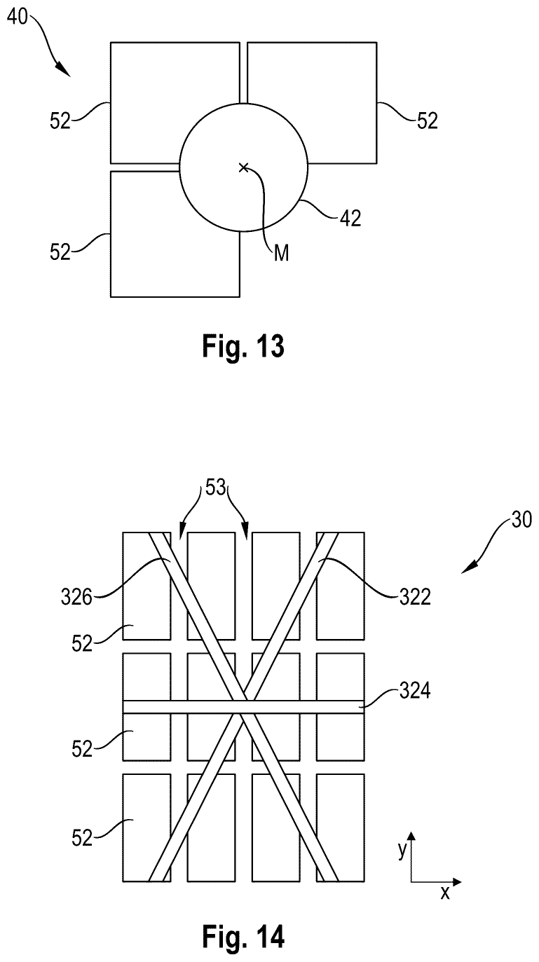

FIG. 13 shows a position transmitting device 40 with a transmitting coil 42 and several flux guide elements 52 (e.g., a GA) in a top view. The transmitting coil 42 is designed as a circular transmitting coil arranged on three flux guide elements 52. The flow guide elements 52 are not arranged symmetrically to the transmitting coil 42. In particular, the lower right part is not supported by a flow guide element 52.

The asymmetrical arrangement of the flow guide element 52 in relation to the transmitting coil 42 (or the axis M) causes a distortion of the magnetic field generated by the transmitting coil 42, so that it is no longer rotationally symmetrical around the axis of the transmitting coil (not shown). In this case, the magnetic field at the bottom right of the circular coil is weaker, so that the magnetic center of the coil does not correspond to its physical center. In practical applications, this requires adjusting the position of the circular coil to ensure that its magnetic center is located at the intended position.

FIG. 14 shows an exemplary embodiment of a position receiving device 30 according to the invention with three receiving coils 322, 324, and 326 wound around several flux guide elements 52. The receiving coils are designed as solenoid coils in this case. Because the solenoid coils are wound around the flow guide elements, the self-inductance of each solenoid coil depends on the size and arrangement of the flow guide elements. Therefore, in practical systems, the solenoid coils generate different induced voltages even when they are in the same position. Since the structure of the position receiving device 30 may vary in terms of length and width (for different VAs), the dimensions of the three coils are not always the same. Furthermore, the distribution of the flow guide elements 52 (four flow guide elements 52 in the x-direction and three flow guide elements 52 in the y-direction are shown as examples) may vary, so that the induced voltage in each receiving coil must also be corrected accordingly. In particular, the number of air gaps 53 between the flux guide elements through which the magnetic flux lines must pass may vary when they pass through different coils.

In the algorithm described above with reference to FIGS. 8A, 8B, and 8C, the effects mentioned can in principle be taken into account by introducing correction factors:

$${u}_{α} = ( cos ( 0 ) * {a}_{1} * {u}_{1} + cos ( {φ}_{2} ) * {a}_{2} * {u}_{2} + ⋯ + cos ( {φ}_{m} ) * {a}_{m} * {u}_{m} + ⋯ + cos ( {φ}_{n} ) * {a}_{n} * {u}_{n} )$$

$${u}_{β} = ( sin ( 0 ) * {a}_{1} * {u}_{1} + sin ( {φ}_{2} ) * {a}_{2} * {u}_{2} + ⋯ + sin ( {φ}_{m} ) * {a}_{m} * {u}_{m} + ⋯ + sin ( {φ}_{n} ) * {a}_{n} * {u}_{n} )$$

$$θ = atan ( {u}_{β} / {u}_{α} )$$

wherein aₘ through aₙ are correction factors for the respective receiving coils, which can be determined by the design of the VA or the arrangement and distribution of the flux guide elements 52 around which the receiving coils are wound.

It is understood that the embodiments shown in the figures are merely exemplary embodiments of the method according to the invention, the position determination device according to the invention, and the position receiving device according to the invention, which are intended to illustrate their advantages. Various modifications can be made to these exemplary embodiments without departing from the scope of the present invention.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The present disclosure may be implemented as a system, a device, a method, and/or a computer program product. The computer program product may include a computer-readable storage medium (or media) having computer-readable program instructions thereon for causing a processor to carry out aspects of the present disclosure.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media/

Any memory device may incorporate electronic, magnetic, optical, and/or other types of storage media. In this context, a “non-transitory computer-readable medium” may include electronic, magnetic, optical, electromagnetic, infrared, or semiconductor-based systems, apparatuses, or devices.

The flowchart and block diagrams in the figures illustrate the architecture, functionality, and operation of possible implementations of systems, methods, and computer program products. Each block may represent a module, segment, or portion of executable instructions for implementing a specific logical function. The execution order of these blocks may vary, and they may be implemented using software, hardware, or a combination of both.

Aspects of the present disclosure are described herein with reference to flowchart illustrations and/or block diagrams of methods, apparatuses (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

For purposes of this document, each process associated with the disclosed technology may be performed continuously and by one or more computing devices. Each step in a process may be performed by the same or different computing devices as those used in other steps, and each step need not necessarily be performed by a single computing device.

The descriptions of various embodiments are for illustration purposes and are not intended to be exhaustive or limiting. Many modifications and variations will be apparent to those skilled in the art without departing from the scope and spirit of the disclosure. The terminology is chosen to best explain the principles, applications, and improvements over existing technologies.

The terms “module” and “component” as used herein generally represent software, firmware, hardware, or combinations thereof. In a software implementation, the module or component represents program code that performs specified tasks when executed on a processor. The program code may be stored in one or more computer-readable memory devices.

A software component may be coded in any of a variety of programming languages, including lower-level languages such as assembly or high-level languages such as C or C++. Assembly instructions may require conversion into machine code before execution by hardware.

Computer-executable program instructions may be loaded onto a special-purpose computer, processor, or other programmable data processing apparatus to produce a particular machine. Execution of the instructions causes one or more functions specified in the flow diagrams to be performed. These instructions may also be stored in a computer-readable storage medium that, when executed, directs a device to function in a specific manner.

Although some methods are described sequentially, the ordering is flexible unless explicitly stated otherwise. Certain operations may be rearranged or performed concurrently. Additionally, for simplicity, the figures may not show all possible interactions between different components.

Any of the disclosed methods can be implemented as computer-executable instructions or a computer program product stored on one or more computer-readable storage media and executed on a computing device (e.g., a mobile phone or any other computing hardware). Computer readable storage media include tangible media accessible within a computing environment, such as optical media (DVD, CD), volatile memory (DRAM, SRAM), or nonvolatile memory (flash memory, hard drives). The term does not include signals, carrier waves, or communication connections.

The disclosure is not limited to the specific embodiments described. Conditional language such as “can,” “could,” “might,” or “may” is intended to indicate optional features, not requirements. Similarly, when elements are introduced with “a,” “an,” or “the,” they may include one or more instances unless explicitly stated otherwise. The terms “comprising,” “including,” and “having” are inclusive, allowing for additional elements beyond those listed.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for determining the position of a position receiving device relative to a position transmitting device, wherein the position receiving device has a first receiving coil and a second receiving coil that are arranged essentially in a receiving plane and whose radial longitudinal directions intersect at an intersection point, the method comprising:
receiving a first voltage signal induced in the first receiving coil by a transmitting coil of the position transmitting device,
receiving a second voltage signal induced in the second receiving coil by the transmitting coil,
evaluating the received first and second voltage signals; and
determining a direction angle between the radial longitudinal direction of the first receiving coil and an imaginary connecting line between the intersection point and the transmitting coil based on the evaluated first and second voltage signals.

2. The method according to claim 1, wherein evaluating the received first and second voltage signals comprises an evaluation of an amplitude and a phase relationship of the first and second voltage signals.

3. The method according to claim 1, further comprising:
determining multiple circular sectors in the receiving plane from the intersection point;
associating the circular sectors with the first and second voltage signals of the receiving coils; and
determining, based on the direction angle, in which of the circular sectors the transmitting coil is located.

4. The method according to claim 1, wherein, in the presence of a minimal first voltage signal, it is determined that the direction angle is essentially 0°; and/or
wherein, in the presence of equal amplitude and opposite phase of the voltage signals, it is determined that the direction angle is essentially half of an angle between the radial longitudinal direction of the first receiving coil and the radial longitudinal direction of the second receiving coil.

5. The method according claim 1, wherein at least the first voltage signal is induced by one or more further transmitting coils of the position transmitting device, wherein the first voltage signal is composed of a first partial voltage induced by the transmitting coil and one or more further partial voltages induced by the one or more further transmitting coils, the method further comprising:
evaluating one or more additional partial voltages of the first voltage signal; and
determining one or more additional direction angles between the radial longitudinal direction of the first receiving coil and the imaginary connecting line between the intersection point and the one or more additional transmitting coils on the basis of the one or more additional evaluated partial voltages of the first voltage signal.

6. The method according to claim 5, wherein the first voltage signal is induced by at least two further transmitting coils, and a first partial voltage of the first voltage signal induced by the transmitting coil and two further partial voltages of the first voltage signal induced by the two further transmitting coils are evaluated, and the method further comprises:
determining whether the intersection point is within a range spanned by the at least transmitting coil and the at least two further transmitting coils.

7. The method according to claim 6, further comprising:
determining an orientation of the position receiving device in the receiving plane.

8. The method according to claim 1, further comprising:
taking into account an influence of a flow guide element, around which one of the receiving coils is wound or on which the transmitting coil is arranged, on the evaluated associated first and second voltage signal when determining the direction angle.

9. A computer program, comprising: a program code for causing a computer to perform the steps of the method claimed in claim 1 when the computer program is executed on the computer.

10. A position determination device for determining a position of a position receiving device relative to a position transmitting device, wherein the position receiving device has a first receiving coil and a second receiving coil that are arranged essentially in a receiving plane and whose radial longitudinal directions intersect at an intersection point, comprising:
a receiving unit for receiving a first voltage signal induced in the first receiving coil by a transmitting coil of the position transmitting device and for receiving a second voltage signal induced in the second receiving coil by the transmitting coil,
an evaluation unit for evaluating the received first and second voltage signals and determining a direction angle between the radial longitudinal direction of the first receiving coil and an imaginary connecting line between the intersection point and the transmitting coil based on the evaluated first and second voltage signals, and
an output unit for providing the direction angle.

11. A position receiving device configured to interact with a position transmitting device, comprising
a receiving coil unit with at least three receiving coils, each of the at least three receiving coils having a radial longitudinal direction and is configured to have a voltage signal induced in it by a respective transmitting coil of the position transmitting device, wherein the receiving coils are arranged essentially in a receiving plane and the radial longitudinal directions intersect at an intersection point, and
a connection for supplying the induced voltage signals to a position determination device.

12. The position receiving device according to claim 11, wherein all angles between radial longitudinal directions of adjacent receiving coils are essentially equal in each case.

13. The position receiving device according to claim 11, wherein at least one of the at least three receiving coils is a solenoid coil and/or at least one of the at least three receiving coils is wound around one or more flux guide elements.

14. A vehicle, comprising the position receiving device according to claim 11.

15. The vehicle according to claim 14, further comprising an induction charging device.

16. The position determination device according to claim 10, wherein the evaluation unit evaluates an amplitude and a phase relationship of the first and second voltage signals.

17. The position determination device according to claim 10, wherein, in the presence of a minimal first voltage signal, it is determined that the direction angle is essentially 0°.

18. The position determination device according to claim 10, wherein, in the presence of equal amplitude and opposite phase of the voltage signals, it is determined that the direction angle is essentially half of an angle between the radial longitudinal direction of the first receiving coil and the radial longitudinal direction of the second receiving coil.

19. The method according to claim 2, further comprising:
determining multiple circular sectors in the receiving plane from the intersection point;
associating the circular sectors with the first and second voltage signals of the receiving coils; and
determining, based on the direction angle, in which of the circular sectors the transmitting coil is located.

20. The method according to claim 2, wherein, in the presence of a minimal first voltage signal, it is determined that the direction angle is essentially 0°.
